(19) United States
(12) Patent Application Publication
(10) Pub. No.: US 2005/0266269 A1
(43) Pub. Date: Dec. 1, 2005

(54) Stress-induced light emitting composite material transparent in visible light range, water-resistive stress-induced light emitting inorganic particles, production methods thereof and use thereof

(75) Inventors: Yusuke Imai, Tosu-shi (JP); Chao-Nan Xu, Tosu-shi (JP)

Correspondence Address: EDWARDS & ANGELL, LLP, P.O. BOX 55874, BOSTON, MA, 02205, US

(73) Assignee: National Institute of Advanced Industrial Science and Technology, Tokyo (JP)

(21) Appl. No.: 11/122,554

(22) Filed: May 4, 2005

(30) Foreign Application Priority Data
May 7, 2004 (JP) 2004-139143

(51) Int. Cl. B32B 9/00

(52) U.S. Cl. 428/698

(57) ABSTRACT

A stress-induced light emitting composite material according to the present invention contains at least stress-induced light emitting inorganic particles, which emit light at application of a mechanical effect thereon and a polymer material. The stress-induced light emitting inorganic particles are not more than a wavelength of visible light in particle diameter and surface-treated. With this arrangement, the stress-induced light emitting composite material becomes transparent in a visible light range. Moreover the surface treatment of the stress-induced light emitting inorganic particles give water resistance to the stress-induced light emitting inorganic particles.

This Nonprovisional application claims priority under 35 U.S.C. § 119(a) on Patent Application No. 2004/139143 filed in Japan on May 7, 2004, the entire contents of which are hereby incorporated by reference.

### FIELD OF THE INVENTION

The present invention relates to a stress-induced light emitting composite material, which is transparent in a visible light range. The transparency of the stress induced light emitting composite material is attained by making it possible to uniformly disperse, in a polymer material, stress-induced light emitting inorganic particles being not more than a wave length of visible light in particle diameter (particle size) and having been subjected to appropriate surface treatment. The present invention further relates to stress-induced light emitting inorganic particles having water resistance by surface treatment. The present invention also relates to production methods for these and typical uses of them.

The present invention is suitably applicable to material industries such as manufacture of a stress-induced light emitting material, a stress-induced light emitting product and a product comprising the stress-induced light emitting material, and the like industries. The stress-induced light emitting inorganic particles according to the present invention having the water resistance is applicable as a coating material, a surface coating agent, or the like. Apart from these, the present invention is expected to be applicable in various fields such as industries for various electronic components, electro-optical devices, safety managements, measuring, robots, toys, and other fields.

### BACKGROUND OF THE INVENTION

Various materials have been proposed conventionally as stress-induced light emitting materials that emit light at application of a mechanical effect thereon such as friction, shear, impact, vibration, or the like. For example, the inventors of the present invention have proposed a high luminance stress-induced light emitting material, which emits strong light in a visible light range when a load is applied thereon. (e.g. Japanese Patent Application Publication, Tokukaihei, No. 11-116946 (published on Apr. 27, 1999), Japanese Patent Application Publication, Tokukai, No. 2002-194349 (published on Jul. 10, 2002), Japanese Patent Publication No. 3511083 (published on Mar. 29, 2004), Japanese Patent Publication No. 3421736 (published on Jun. 30, 2003), Japanese Patent Publication No. 3273317 (published on Apr. 8, 2002), Japanese Patent Publication No. 3136340 (published on Feb. 19, 2001), Japanese Patent Publication No. 3136338 (published on Feb. 19, 2001).

Specific examples of the light emitting materials are: (a) A powder-form inorganic material and bulk inorganic material, prepared by adding to a mother material (i.e. matrix) a luminescence center in an amount of 0.01 mol % to 20 mol % with respect to a total amount. The luminescence center is made of one or more kinds of rare earths or transition metals, each of which emits light when returning to a stable condition (i.e. ground state) after electrons constituting its atom is exited by an electric field in the mother material, the electric field induced by a mechanical energy. The mother material is made of one or more of oxides, sulfides, carbides, nitrides, each of which is inorganic and piezo-electric and has a wurtzite structure. (c.f. Japanese Patent Application Publication No. 11-116946 (published on Apr. 27, 1999); (b) A stress-induced light emitting material whose mother material is an oxide made of a compound represented by a formula MN₂O₄ (where M is one or more of metal elements, Mg, Sr, Ba, and Zn, and N is one or more of metal elements Ga and Al) (c.f. Japanese Patent Application Publication No. 2002-194349 (published on Jul. 10, 2002). Moreover, the inventors of the present invention also have proposed a method for manufacturing spherical particles, the method enabling to attain a high luminance light emitting material prepared by uniformly dispersing a luminescence center in a mother material. In the method, the homogeneous dispersion is attained by using spherical crystalline particulates prepared by (i) preparing a solution prepared by dissolving in a solvent a raw material component for the mother material and a raw material for the luminescence center, (ii) atomizing the solution in a reduction atmosphere, and then (iii) heating the atomized solution. (e.g. Japanese Patent Application Publication, Tokukai, No. 2002-194349 (published on Jul. 10, 2002), Japanese Patent Publication No. 3511083 (published on Mar. 29, 2004), Japanese Patent Publication No. 3421736 (published on Jun. 30, 2003), Japanese Patent Publication No. 3273317 (published on Apr. 8, 2002), Japanese Patent Publication No. 3136340 (published on Feb. 19, 2001), Japanese Patent Publication No. 3136338 (published internationally on Feb. 19, 2001), International Patent Application Publication No. WO03/045842A1 (published internationally on Jun. 5, 2003), Japanese Patent Application Publication, Tokukai, No. 2003-292949 (published on Oct. 15, 2003).

Examples of a composite material in which particles having a stress-induced light emitting property are dispersed in a polymer material is disclosed, e.g. in International Application Publication No. WO03/045842A1 (published internationally on Jun. 5, 2003), Japanese Patent Application Publication, Tokukai, No. 2003-292949 (published on Oct. 15, 2003), and the like. In these publications, stress-induced light emitting property is evaluated by applying a mechanical effect (such as compression, extension, friction, twisting, or the like) on a test piece, the test piece prepared from a composite material containing the particles and an epoxy resin.

Apart from these, it has been proposed to form a composition by mixing (a) europium-added strontium aluminate which having a stress-induced light emitting property, with (b) any one of polymethylmethacrylate, ABS (acrylonitrile-butadiene-styrene) resin, polycarbonate, polystyrene, polyethylene, polyacetal, urethane resin, polyester, epoxy resin, silicone rubber, an organic silicone compound having a siloxane bond, and an organic piezo material (Japanese Patent Application Publication, Tokukai, No. 2003-253261 (published on Sep. 10, 2003), and Japanese Patent Application Publication, Tokukai, No. 2004-71511 (published on Mar. 4, 2004)).

Moreover, it has been proposed to mix a stress-induced light emitting material in a particle form with an adhesive agent that is epoxy-based, silicone-based, or acrylic (Japanese Patent Application Publication, Tokukai, No. 2003-140569 (published on May 16, 2003).

In general, the stress-induced light emitting inorganic particles are weak against water: water breaks a crystalline structure of the stress-induced light emitting inorganic particles, thereby depriving a light emitting property from the stress-induced light emitting inorganic particles.

As described above, there are various examples of the composite materials in which a stress-induced light emitting material is dispersed in a polymer material. The composite material according to conventional techniques are, however, prepared by mechanically mixing the stress-induced light emitting inorganic particles into a polymer material, which serves as a matrix (mother body). Therefore, even if the stress-induced light emitting inorganic particles of 100 nm or less in particle diameter is used, it is not possible to prevent the stress-induced light emitting inorganic particles from being agglomerated. The agglomeration results in phase separation between a polymer phase (i.e. organic phase) and an inorganic particle phase (i.e. inorganic phase). Because of this, the inorganic particle phase becomes larger than a wave length (in a range of 400 nm to 700 nm) of visible light. In general, a material system in which different kinds of material having different refractive indexes are mixed is such that visible light incident therein is greatly scattered in a case where a size of a dispersed phase is equal to or larger than the wavelength of the visible light. Therefore, in this case, the mixture system is not transparent in the visible light range macroscopically. That is, the composite material made from the conventional stress-induced light emitting inorganic particles and the polymer material has a problem in that light emitted inside of the composite material is scattered therein and cannot be transmitted out of the composite material efficiently. As a result, only light emitted from a surface of the composite material can be observed. Furthermore, there has been no technique proposing giving water resistance to the stress-induced inorganic particles.

### SUMMARY OF THE INVENTION

An object of the present invention is to provide a stress-induced light emitting composite material, which is transparent in a visible light range. The transparency of the stress induced light emitting composite material is attained by making it possible to uniformly disperse, in a polymer material, stress-induced light emitting inorganic particles being not more than a wavelength of visible light in particle diameter (particle size) and having been subjected to appropriate surface treatment. Another object of the present invention is to provide stress-induced light emitting inorganic particles having water resistance by surface treatment. Still another object of the present invention is to provide production methods for these and typical uses of them.

In view of the aforementioned problems, the diligent work of the inventors of the present invention reached a unique finding that a macroscopically transparent material can be obtained when a dispersion phase is not more than a wavelength of visible light in size as a result of uniform mixing of an organic phase and an inorganic phase in mixing surface-treated stress-induced light emitting inorganic particles and a polymer material, where the surface-treated stress-induced light emitting inorganic particles is prepared by surface-treating (i.e. subjecting to surface treatment) stress-induced light emitting inorganic particles, thereby to have a high affinity with the polymer material that is to serve a matrix, which is not more than a wavelength of the visible light in particle diameter, the stress-induced light emitting inorganic particles being not more than a wavelength of visible light. The present invention is based on this finding.

A stress-induced light emitting composite material according to the present invention is so arranged as to include at least (a) stress-induced light emitting inorganic particles, which emit light at application of a mechanical effect thereon, (b) and a polymer material. The stress-induced light emitting inorganic particles are not more than a wavelength of visible light in particle diameter and are surface-treated, and the stress-induced light emitting composite material is transparent in a visible light range.

In the present invention, the stress-induced light emitting inorganic particles being not more than the wavelength of the visible light in particle diameter are subjected to an appropriate surface treatment. This makes it possible to uniformly mix the stress-induced light emitting inorganic particles with the polymer material. With this, agglomeration of the stress-induced light emitting inorganic particles is prevented and the dispersion phase is caused not to be larger than the wavelength of the visible light. As a result, the composite material of the stress-induced light emitting inorganic particles and the polymer material (i.e. the stress-induced light emitting composite material) becomes transparent macroscopically. Therefore, the stress-induced light emitting composite material is such that all light emitted at the application of stress thereon can be efficiently transmitted outside. This allows to utilize full performance of the stress-induced light emitting composite material.

Moreover, a method according to the present invention for producing a stress-induced light emitting composite material is so arranged as to include (a) subjecting to surface treatment stress-induced light emitting inorganic particles being not more than a wavelength of visible light in particle diameter; and (b) compounding the thus surface-treated stress-induced light emitting inorganic particles and a polymer material. The stress-induced light emitting composite material produced by this method includes at least (a) the stress-induced light emitting inorganic particles, which emit light at application of a mechanical effect thereon, and (b) the polymer material. The stress-induced light emitting inorganic particles are not more than a wavelength of visible light in particle diameter and is surface-treated.

With this arrangement, the organic phase and the inorganic phase are uniformly mixed, and the dispersion phase is caused not to be more than wavelength of the visible light. As a result, the composite material can be transparent macro scopically.

Moreover, stress-induced light emitting inorganic particles according to the present invention emit light at application of a mechanical effect thereon. According to the present invention, the stress-induced light emitting inorganic particles are arranged such that the stress-induced light emitting inorganic particles are surface-treated to have water resistance. With this arrangement, it is possible to overcome a drawback of the stress-induced light emitting inorganic particles, namely, weakness against water. Therefore, it becomes possible to prevent breakdown of a crystalline structure thereof, or loss of light emission property therefrom. Furthermore, a method according to the present invention for producing water resistant stress-induced light emitting inorganic particles is so arranged as to include subjecting to surface treatment stress-induced light emitting inorganic particles so as to give water resistance to the stress-induced light emitting inorganic particles. For a fuller understanding of the nature and advantages of the invention, reference should be made to the ensuing detailed description taken in conjunction with the accompanying drawings.

### DESCRIPTION OF THE EMBODIMENTS

One exemplary embodiment (hereinafter, “present embodiment”) of the present invention is described below. The following description is not to limit the present invention.

The present embodiment firstly explains a stress-induced light emitting composite material according to the present invention and then a method for producing the same. Secondly, the present embodiment describes a stress-induced light emitting inorganic particles having water resistance, and then a method for producing the same. After that, use of the present invention is explained. In the following, the stress-induced light emitting inorganic particles having water resistance is referred to as “water resistant stress-induced light emitting inorganic particles”.

(1) Stress-Induced Light Emitting Composite Material

The stress-induced light emitting composite material according to the present invention contains at least stress-induced light emitting inorganic particles and a polymer material. The stress-induced light emitting inorganic particles emit light at application of a mechanical effect thereon. The stress-induced light emitting inorganic particles are not more than a wavelength of visible light in particle diameter. Further, the stress-induced light emitting inorganic particles have been subjected to surface treatment. Moreover, the stress-induced light emitting inorganic particles are transparent in a visible light range. As long as the stress-induced light emitting composite material contains at least stress-induced light emitting inorganic particles and a polymer material, the stress-induced light emitting composite material may contain an other additive provided that transparency of the stress-induced light emitting composite material is not reduced by the additive.

Here, the “other additive” may be, for example, a fire retardant, a heat stabilizer, an antioxidant, anti ultraviolet agent, a plasticizer, nucleating agent, a foaming agent, an antibacterial/anti-mildew agent, a filler, a reinforcing agent, a conductive filler, an antistatic agent, or the other agent.

The following explains (a) the stress-induced light emitting inorganic particles as a raw material of the stress-induced light emitting composite material according to the present invention,
(b) a polymer material to serve as a matrix, and (c) the surface treatment of the stress-induced light emitting inorganic particles.

<Stress-Induced Light Emitting Inorganic Particles as Raw Material of Stress-Induced Light Emitting Composite Material>

In the present invention, stress-induced light emitting inorganic particles are used, which emits light in a visible light range by causing stress inside thereof at application of mechanical effect thereon such as friction, shear, impact, vibration, or the like, and which are not more than a wavelength of visible light in particle diameter.

Here, the stress-induced light emitting inorganic particles contain, as a center ion of a luminescence center, one or more kinds of metal ions in an inorganic mother material. The one or more kinds of metal ions, which are selected from rare earths or transit metals, emit light when electrons exited by a mechanical energy returns to a ground state.

Composition of the stress-induced light emitting inorganic particles is not particularly limited, provided that the composition allows the stress-induced light emitting inorganic particles to emit light in an intensity proportional to a magnitude of a stress caused by load externally applied thereon. For example, the inorganic mother material may be an oxide, a sulfide, a nitride, a carbide, or the like.

The oxide is preferably a compound represented by a formula xMO.yQ₂O₃.zGO₂, where M is any one of Sr, Mg, Ba, and Zn, Q is any one of Al, Ga, Y and In, and G is any one of Ti, Zr, Si and Sn, and x, y, and z are independently integers not less than 0.

M, Q, and G may be substituted with one or more kinds of metal ions partially. Specific examples of the sulfide are ZnS, CdS, MnS, MoS₃, MnS₂, and the like. Moreover, specific examples of the nitride are AlN, GaN, InN, TaN, and the like. Specific examples of the carbide are SiC, TiC, BC, and the like. Of these inorganic mother materials, aluminates and zinc sulfide are especially preferable.

Moreover, it is preferable that the stress-induced light emitting particles be made from at least one of aluminates that have a non-stoichiometric composition, and their mother material is a material having a lattice defect that causes light emission when electrons exited by mechanical energy return to ground state. Further, the mother material may contain, as the center ion of the luminescence center, at least one metal ion selected from rare earth metal ions and transition metal ions. The “non-stoichiometric composition” denotes a composition having a chemical composition formula deviated from stoichiometric chemical composition formula.

Examples of the rare earth metal ions that can be selected as the center ion of the luminescence center are the following ions: Sc, Y, La, Ce, Pr, Nd, Pm, Sm, Eu, Gd, Tb, Dy, Ho, Er, Tm, Yb, Lu, and the like ions. On the other hand, examples of the transition metal ions that can be selected as the center ion of the luminescence center are the following ions: Ti, Zr, V, Cr, Mn, Fe, Co, Ni, Cu, Zn, Nb, Mo, Ta, W, and the like ions.

By causing the mother material to contain the center ion of the luminescence center therein, it is possible to attain a greater intensity of light emitted from the stress-induced light emitting inorganic particles. As a result, the stress-induced light emitting composite material is improved to be able to emit light in a greater light intensity. Especially in a case where the mother material is SrAl₂O₄ and contains therein a rare earth metal ion such as Sm, Eu, Gd, Tb, Dy or the like, it is possible to cause the stress-induced light emitting composite material to emit light in a strong light intensity when a stress is applied on the stress-induced light emitting composite material.

These stress-induced light emitting inorganic particles may be used solely or in combination.

In order to cause the stress-induced light emitting composite material to be transparent in the visible light range, the stress-induced light emitting inorganic particles should be not more than wavelength of the visible light (400 nm to 700 nm) in particle diameter. The stress-induced light emitting inorganic particles and the polymer material are different in refractive index. Therefore, in case the stress-induced light emitting inorganic particles have a particle diameter greater than the wavelength of the visible light, light transmitting through the stress-induced light emitting composite material is scattered at interface between the stress-induced light emitting inorganic particles and the polymer material, even if the stress-induced light emitting inorganic particles and the polymer material is uniformly dispersed in the polymer material as the matrix. In this case, the stress-induced light emitting composite material is not transparent in the visible light range.

Even though it is sufficient that the particle diameter is not more than the wavelength of the visible light (400 nm to 700 nm), a small particle diameter is preferable in the present invention. Specifically, in the present invention, the particle diameter is preferably 200 nm or less, and more preferably 100 nm or less. The smaller the particle diameter, the more transparent in the visible light range the stress-induced light emitting composite material prepared by uniformly dispersing the stress-induced light emitting inorganic particles in the polymer material.

There is no particular limitation in how to cause the stress-induced light emitting inorganic particles to be not more than the wavelength of the visible light in the particle diameter. For example, conventionally known methods may be used to cause the stress-induced light emitting inorganic particles to be not more than the wavelength of the visible light in the particle diameter.

The conventionally known methods are, e.g., known methods for pulverizing and classifying, methods for forming single crystal spherical particles by (i) preparing a solution by dissolving in a solvent a raw composition for forming a mother material and a raw composition for forming a luminescence center, (ii) atomizing the solution in a reduction atmosphere, and then (iii) heating the atomized solution (c.f. International Patent Application Publication No. WO03/045842A1 (published internationally on Jun. 5, 2003, and Japanese Patent Application Publication, Tokukai, No. 2003-292949 (published on Oct. 15, 2003), and the like method.

<Polymer Material as Matrix>

The polymer material for use in the present invention to serve as the matrix is not particularly limited, provided that the polymer material can be formed to be transparent in the visible light range.

For example, the polymer material may be: acrylic resin (such as polymethylmethacrylate, and the like); aromatic polyesters (such as polycarbonate, polyethyleneterephthalate, and the like); aliphatic polyesters such as polylactic acid, and the like); polyamide, polyimide, polystyrene, polyolefin, poly(vinylidene fluoride), and copolymer thereof; ABS resin; poly(vinyl chloride); ethylene-vinyl alcohol copolymer; polyacetal; epoxy resin; urethane resin; silicone rubber; thermoplastic elastomer; or the like.

Moreover, the polymer material may contain an other additive, provided that the other additive does not deteriorate transparency of the polymer material. Here, the other additive may be, for example, a fire retardant, a heat stabilizer, an antioxidant, anti ultraviolet agent, a plasticizer, nucleating agent, a foaming agent, an antibacterial/anti-mildew agent, a filler, a reinforcing agent, a conductive filler, an antistatic agent, or the other agent.

<Surface Treatment of Stress-Induced Light Emitting Inorganic Particles>

The stress-induced light emitting inorganic particles have low affinity with the polymer material that is to serve as the matrix. Therefore, even if the stress-induced inorganic particles are not more than the wavelength (400 nm to 700 nm) of the visible light in the particle diameter, mechanical mixing is not sufficient to prevent the particles from being agglomerated to be agglomeration larger than the wavelength of the visible light. Thus, mechanical mixing is not sufficient to attain the stress-induced light emitting composite material that is transparent in the visible light range.

As a result of diligent work to find how to cause the stress-induced light emitting composite material to be transparent in the visible light range, the inventors of the present invention found out that it is necessary to subject, to a surface treatment, the stress-induced light emitting inorganic particles as the raw material (i.e. before adding the stress-induced light emitting inorganic particles into the polymer material).

The surface treatment gives the stress-induced light emitting inorganic particles a high affinity with respect to the polymer material that is to serve as the matrix. Thus, after the surface treatment, it becomes easy to uniformly disperse the stress-induced light emitting inorganic particles in the polymer material. As a result, it becomes possible to cause the stress-induced light emitting composite material to be transparent in the visible light.

Moreover, it is possible to give water resistance to the stress-induced light emitting inorganic particles by subjecting them to such surface treatment. Therefore, it is possible to cause the stress-induced light emitting composite material to be water resistive.

There is no particular limitation in a compound to perform the surface treatment (hereinafter, this compound is referred to as “surface treating agent” for the sake of easy explanation), provided that the compound is an organic compound that has a functional group reactive with surfaces of the stress-induced light emitting inorganic particles. It is preferable that the compound be a compound having an acidic group or an ester thereof. The acidic group is preferably at least one of phosphonic acid group, phosphinic acid group, sulfonic acid group, carboxylic acid group, and silanol group. Among them, phosphonic acid group is most preferable.

There is no particular limitation in molecular weight of the surface treating agent, provided that the surface treating agent has at least any one of the functional groups. As to a number of the functional groups, the surface treating agent may have one or more groups. There is no particular limitation in terms of location of the functional group: The functional group may be bonded as a side chain or a terminal group.

There is no particular limitation in terms of a method of the surface treatment, provided that the method can cause the surface treating agent to react with the stress-induced light emitting inorganic particles. For example, the following preferable method can be preferably used to cause the surface treating agent to react with the stress-induced light emitting inorganic particles: dissolve the surface treating agent in an organic solvent to prepare a solution; add the stress-induced light emitting inorganic particles into the solution; and then stir the solution.

(2) Method for Producing Stress-Induced Light Emitting Composite Material

A method according to the present invention for producing the stress-induced light emitting composite material is so arranged as to include subjecting to surface treatment stress-induced light emitting inorganic particles being not more than a wavelength of visible light in particle diameter (so as to give water resistance to the stress-induced light emitting inorganic particles); and compounding the thus surface-treated stress-induced light emitting inorganic particles and a polymer material, the stress-induced light emitting composite material containing at least (a) the stress-induced light emitting inorganic particles, which emit light at application of a mechanical effect thereon, and (b) the polymer material, the stress-induced light emitting inorganic particles being not more than a wavelength of visible light in particle diameter and being surface-treated.

As to its composition, the stress-induced light emitting inorganic particles are not particularly limited, provided that the composition allows the stress-induced light emitting inorganic particles to emit light in the intensity proportional to the magnitude of the stress caused by load externally applied thereon, as described in (1). Moreover, it is sufficient for the stress-induced light emitting inorganic particles that they are not more than the wavelength of the visible light (400 nm to 700 nm). However, a small particle diameter is preferable in the present invention.

Specifically, it is preferable that the stress-induced light emitting inorganic particles be not more than 200 nm. It is more preferable that the stress-induced light emitting inorganic particles be not more than 100 nm. As described in (1), the polymer material to serve as the matrix is not particularly limited, provided that the polymer material can be formed to be transparent in the visible light range.

As described in (1), there is no particular limitation in the surface treating agent, provided that the surface treating agent is an organic compound that has a functional group reactive with the surface of the stress-induced light emitting inorganic particles. It is preferable that the compound be a compound having an acidic group or an ester thereof. The acidic group is preferably at least one of phosphonic acid group, phosphinic acid group, sulfonic acid group, carboxylic acid group, and silanol group. Among them, phosphonic acid group is most preferable.

Next, a surface treating step and a compounding step are described below.

<Surface Treating Step>

The surface treating step is not particularly limited, provided that the surface treating step can cause the surface treating agent to react with the stress-induced light emitting inorganic particles. For example, the following method can be preferably used for causing the surface treating agent to react with the stress-induced light emitting inorganic particles: dissolve the surface treating agent in an organic solvent to prepare a solution; add the stress-induced light emitting inorganic particles into the solution; and then stir the solution.

<Compounding Step>

There is no particular limitation in the compounding step, provided that the stress-induced light emitting inorganic particles thus surface-treated can be uniformly dispersed in the polymer material by the compounding step. A ultrasonic method and a melting, mixing and kneading method are specific examples that can be preferably used. The ultrasonic method is as follows: dissolve the polymer material in an organic solvent so as to prepare a solution; add, to the solution, the stress-induced light emitting inorganic particles thus surface treated; and then apply ultrasonic wave to the solution. The melting, mixing and kneading method is as follows: melt, mix and knead the stress-induced light emitting inorganic particles thus surface-treated and the polymer material.

Here, the ultrasonic method is not particularly limited and may be performed by a ultrasonic cleaning apparatus commercially available. Moreover, there is no particular limitation in terms of temperature at which the ultrasonic method is performed. However, it is preferable that the ultrasonic method be performed at a room temperature. Here, the word “room temperature” denotes any temperature in a general range of room temperatures. More specifically, the room temperature is in a range of 15° C. to 25° C. Moreover, there is no particular limitation in terms of processing time. Furthermore, there is no particular limitation in the melting, mixing and kneading method, provided that the stress-induced light emitting inorganic particles thus surface-treated can be uniformly dispersed in the polymer material by the melting, mixing and kneading method.

A method according to the present invention for producing the stress-induced light emitting composite material should be arranged to include the compounding step and to include the surface treating step (or use the stress-induced light emitting inorganic particles thus surface-treated). However, the method according to the present inventions may include an other step. Specifically, for example, the method according to the present invention for producing the stress-induced light emitting composite material may include shaping, by hot-pressing, the stress-induced light emitting composite material thus formed to a film-like shape, or the like step.

(3) Water Resistant Stress-Induced Light Emitting Inorganic Particles

Water resistant stress-induced light emitting inorganic particles can be obtained by surface-treated stress-induced light emitting inorganic particles as a raw material, as described in (1). As described in (1), composition of the stress-induced light emitting inorganic particles is not particularly limited, provided that the composition allows the stress-induced light emitting inorganic particles to emit light in the intensity proportional to the magnitude of the stress caused by load externally applied thereon.

In the present invention, there is no particular limitation in terms of the particle diameter of the stress-induced light emitting inorganic particles. Regardless of the particle diameter, it is possible to give the stress-induced light emitting inorganic particles water resistance by treating the surface of stress-induced light emitting inorganic particles. Of course, as the raw material for the stress-induced light emitting composite material, the stress-induced light emitting inorganic particles are not more than the wavelength of the visible light (400 nm to 700 nm) in particle diameter preferably. By using the stress-induced light emitting inorganic particles as such, it is possible to give water resistance to the stress-induced light emitting composite material. As described in (1), there is no particular limitation in a surface treating agent, provided that the surface treating agent is an organic compound that has a functional group reactive with the surface of the stress-induced light emitting inorganic particles. It is preferable that the compound be a compound having an acidic group or an ester thereof. The acidic group is preferably at least one of phosphonic acid group, phosphinic acid group, sulfonic acid group, carboxylic acid group, and silanol group. Among them, phosphonic acid group is most preferable.

There is no particular limitation in terms of a method of the surface treatment, provided that the method can cause the surface treating agent to react with the stress-induced light emitting inorganic particles. For example, the following preferable method can be preferably used to cause the surface treating agent to react with the stress-induced light emitting inorganic particles: dissolve the surface treating agent in an organic solvent to prepare a solution; add the stress-induced light emitting inorganic particles into the solution; and then stir the solution.

The water resistant stress-induced light emitting inorganic particles overcomes the problem associated with the stress-induced light emitting inorganic particles in that the stress-induced light emitting inorganic particles are weak against water. The water resistance prevents breaking-down of a crystalline structure of the stress-induced light emitting inorganic particles and loss of the light emitting property thereof.

(4) Method for Producing Water Resistant Stress-Induced Light Emitting Inorganic Particles

A method according to the present invention for producing water resistant stress-induced light emitting inorganic particles includes the surface treating step as described in (1), so as to surface-treat stress-induced light emitting inorganic particles. As described in (1), composition of the stress-induced light emitting inorganic particles as a raw material, the stress-induced light emitting inorganic particles are not particularly limited, provided that the composition allows the stress-induced light emitting inorganic particles to emit light in the intensity proportional to the magnitude of the stress caused by load externally applied thereon. In the present invention, there is no particular limitation in terms of the particle diameter of the stress-induced light emitting inorganic particles. Regardless of the particle diameter, it is possible to give the stress-induced light emitting inorganic particles water resistance by treating the surface of stress-induced light emitting inorganic particles. As described in (1), there is no particular limitation in a surface treating agent, provided that the surface treating agent is an organic compound that has a functional group reactive with the surface of the stress-induced light emitting inorganic particles. It is preferable that the compound be a compound having an acidic group or an ester thereof. The acidic group is preferably at least one of phosphonic acid group, phosphinic acid group, sulfonic acid group, carboxylic acid group, and silanol group. Among them, phosphonic acid group is most preferable.

(5) Use of Present Invention (Utility)

There is no particular limitation in use (application) of the present invention. The present invention is applicable to any fields in which stress-induced light emission is performed by using a stress-induced light emitting composite material or the like.

It is firstly found out by the inventors of the present invention that, by appropriately treating the surface of the stress-induced light emitting inorganic particles being not more than the wavelength of the visible light range in particle diameter, it is possible to uniformly disperse the stress-induced light emitting inorganic particles in the polymer material that serves as the matrix, and the even dispersion allows formation of the stress-induced light emitting composite material transparent in the visible light range. The stress-induced light emitting composite material according to the present invention is accomplished based on this finding. Because of the transparency, the light emitted by the stress-induced light emitting composite material can be transmitted out of the stress-induced light emitting composite material efficiently. Therefore, the present invention is applicable for producing high luminance coating materials, surface covering materials, ink, light emitting elements, light accumulating materials and the like.

Moreover, the water resistant stress-induced light emitting inorganic particles have a large water resistance, which the conventional stress-induced light emitting inorganic particles cannot obtain. Therefore, the water resistant stress-induced light emitting inorganic particles can be used as a raw material for a coating material. Especially the water resistant stress-induced light emitting inorganic particles can be used suitably as a raw material for a water-based coating material.

The coating material containing the water resistant stress-induced light emitting inorganic particles can visualize distribution of a secondary-caused stress on an article on which the coating material is applied. Therefore, this coating material is highly useful as a novel high luminance coating material. Moreover, the water resistant stress-induced light emitting inorganic particles can be used as a raw material as a surface coating material. For example, by coating powder with the surface coating material containing the water resistant stress-induced light emitting inorganic particles, it is possible to prevent the powder from deteriorating another component that coexists with the powder.

Here, the “coating materials” are a kind of materials that are used for protecting a surface of an article, changing an outer appearance and/or shape of an article, and for other purposes. Moreover, the surface coating agent is a material that can be an outer layer that cover a material, and is not limited to the coating material.

As described above, the present invention is based on the finding that the water resistance of the stress-induced light emitting composite material can be largely improved by surface-treating (i.e. treating the surfaces of) the stress-induced light emitting inorganic particles. With this, the stress-induced light emitting composite material can be transparent macroscopically, and will not lose its light emitting property even in water because of the water resistance. Moreover, it is possible to prevent water-causing breakdown of crystalline structure and loss of light emission property.

Therefore, the coating material or the surface coating material, each of which contains the water-resistant stress-induced light emitting inorganic particles according to the present invention can visualize distribution of the secondary-caused stress on the article on which the coating material is applied.

Moreover, it is preferable in the stress-induced light emitting composite material according to the present invention that the stress-induced light emitting inorganic particles be subjected to surface treatment with a compound having an acidic group or an ester thereof. Further, the acidic group is preferably at least one of phosphonic acid group, phosphinic acid group, sulfonic acid group, carboxylic acid group, and silanol group. Moreover, it is preferable in the stress-induced light emitting composite material according to the present invention that the stress-induced light emitting inorganic particles be not more than 200 nm in particle diameter. The particle size not more than 200 nm allows the stress-induced light emitting composite material to be transparent in the visible light range, the stress-induced light emitting composite material prepared by mixing the stress-induced light emitting inorganic particles and the polymer material uniformly. Furthermore, a method according to the present invention is arranged such that in the step of subjecting to the surface treatment, a compound having an acidic group or an ester thereof is used to perform the surface treatment.

Moreover, the acidic group is at least one of phosphonic acid group, phosphinic acid group, sulfonic acid group, carboxylic acid group, and silanol group. It is preferable in the stress-induced light emitting composite material according to the present invention that the stress-induced light emitting inorganic particles be not more than 200 nm in particle diameter. Moreover, a method according to the present invention is arranged such that the step of compounding includes (a) subjecting, to an ultrasonic treatment, the stress-induced light emitting inorganic particles thus surface-treated and the polymer material, or (b) melting, mixing, and kneading the stress-induced light emitting inorganic particles thus surface-treated and the polymer material.

Moreover, stress-induced light emitting inorganic particles according to the present invention is arranged such that the surface treatment is carried out with a compound having an acidic group or an ester thereof. Moreover, the acidic group is preferably at least one of phosphonic acid group, phosphinic acid group, sulfonic acid group, carboxylic acid group, and silanol group.

A coating material contains stress-induced light emitting inorganic particles according to the present invention, which has water resistance. It is preferable that the coating material be a water-based coating material. A surface coating material according to the present invention contains stress-induced light emitting inorganic particles according to the present invention, which has water resistance. A method according to the present invention for producing water resistant stress-induced light emitting inorganic particles is arranged such that the surface treatment is carried out with a compound having an acidic group or an ester thereof. The acidic group is preferably at least one of phosphonic acid group, phosphinic acid group, sulfonic acid group, carboxylic acid group, and silanol group.

In the following, the present invention is more specifically described, referring to Examples, which are not to limit the present invention. It is possible for person having ordinary skill in the art to make a change, modification, correction on the present invention, and the scope of the present invention includes such a change, modification, correction on the present invention.

In the following Examples and Comparative Examples, Europium-added strontium aluminate (hereinafter SAO:E) of 50 nm in particle diameter was used as the stress-induced light emitting particles. SAO:E was prepared in accordance with a method described in International Patent Application Publication No. WO03/045842A1 (published internationally on Jun. 5, 2003).

Firstly, 0.00495 mol of strontium nitrate (Sr (NO₃)₂), 0.01 mol of aluminum nitrate (Al(NO₃)₃.9H₂O), and 0.00005 mol of nitric europium (Eu(NO₃)₃.2.4H₂O) were added into a mixture of 75 ml of distilled water and 25 ml of ethyl alcohol. 0.5 g of a surfactant was further added in the mixture. Then, the mixture was stirred uniformly to prepare a raw material solution uniformly mixed.

Next, the raw material solution was atomized by using a multi-microchannel sprayer (pore diameter: 0.05 mm). The atomization was carried out by flowing compressed oxygen at a rate of 3 L per minute while supplying the raw material solution kept at 40° C. to the micro-size atomizer by using an automatic pump. Atomized particles thus formed were introduced into an electric oven to be subjected to a temperature which was 1300° C. at maximum, so as to dry and bake the atomized particles. Thereby powder was obtained. The power was collected in an ordinary collector first. Then, SAO:E was collected into an electrostatic particle collector, thereby preparing particles as a raw material.

### EXAMPLE 1

### Surface Treatment of Particles with Low-Molecular-Weight Compound having Phosphonic Acid Group and Preparation of Composite Material of Particles and Polymethylmethacrylate, “First Method”

A surface treating agent used was (2-hydroxyethyl)methacrylate acid phosphate (Product Name: JPA-514, made by Johoku Chemical Co. Ltd.), which was a low-molecular-weight having a phosphonic acid group. In water/ethanol mixture solvent (8 g+2 g), 0.5 g of JPA-514 was dissolved and then 0.1 g of SAO:E was added. After that, a solution thus prepared was stirred at 60° C. for one hour. Next, the particles were separated from the solution by centrifugation, and washed with ethanol. Thereby, surface-modified SAO:E1 was obtained.

One gram of polymethylmethacrylate (hereinafter “PMMA”) was dissolved in 10 g of toluene, to a mixture solution. Then, 0.05 g of the surface-modified SAO:E1 was added to the mixture solution. After subjected to ultrasonic treatment, the mixture solution was cast on a glass board. Then, toluene was evaporated off therefrom. Thereby, a film of 100 μm in thickness was obtained. The ultrasonic treatment was carried out at a room temperature for 5 minutes by using a ultrasonic clearing apparatus (Product Name: US-2; Oscillation Frequency: 38 kHz; made by SND Corp.)

### EXAMPLE 2

### Surface Treatment of Particles with Low-Molecular-Weight Compound having Phosphonic Acid Group and Preparation of Composite Material of Particles and Polymethylmethacrylate, “Second Method”

One gram of PMMA and 0.05 g of the surface-modified SAO:E1 was melt, mixed and kneaded at 220° C. for 5 minutes by using a small-size twine-screw extruder (Product Name: MiniLab; made by ThermoHaake), rotating screws in different rotation directions at a rotation rate of 60 rpm. Thereby pellets were obtained. The thus obtained pellets were sandwiched by a pair of Teflon (Registered Trademark) sheets of 0.2 mm in thickness. Then, the pellets sandwiched between the Teflon sheets were subjected to hot pressing by keeping the pellets for 1 minute under application of a temperature of 160° C. and a force of 10 MPa by using a small-size hot pressing apparatus (size of a pressing board: 160 mm×160 mm made by Imoto Manufacturing Co. Ltd.). Thereby a film of 100 μm in thickness was obtained.

### EXAMPLE 3

### Surface Treatment of Particles with High-Molecular-Weight Compound having Side Chain of Phosphonic Acid Group and Preparation of Composite Material of Particles and Polymethylmethacrylate, “Third Method”

Into 8 ml of toluene, 0.9 g (9 mmol) of methylmethacrylate, 0.21 g (1 mmol) of JPA-514, and 0.03 g of azobis(isobutyronitrile) were dissolved. Then, thus prepared solution was heated at 70° C. for 18 hours, thereby synthesizing a high-molecular compound 1 having a side chain of a phosphonic acid group. Then, 0.5 g of the high-molecular weight compound 1 was dissolved in tetrahydrofuran. Then, to a thus formed mixture solution, 0.05 g of SAO:E was added. Next, the mixture solution was stirred at 60° C. for 1 hour. After that, particles were separated therefrom by centrifugation and washed with ethanol. Thereby surface-modified SAO:E2 was obtained.

One gram of PMMA was dissolved in 10 g of toluene, so as to prepare a mixture solution. Then, 0.05 g of surface-modified SAO:E2 was added to the mixture solution. After subjected to ultrasonic treatment, the mixture solution was cast on a glass board. Then, toluene was evaporated off therefrom. Thereby, a film of 100 μm in thickness was obtained.

### EXAMPLE 4

### Surface Treatment of Particles with High-Molecular-Weight Compound having Side Chain of Phosphonic acid group and Preparation of Composite Material of Particles and Polymethylmethacrylate, “Fourth Method”

One gram of PMMA and 0.05 g the surface-modified SAO:E2 was melt, mixed and kneaded at 220° C. for 5 minutes by using a small-size twine-screw extruder (Product Name: MiniLab; made by ThermoHaake), rotating screws in different rotation directions at a rotation rate of 60 rpm. Thereby pellets were obtained. The thus obtained pellets were sandwiched by a pair of Teflon (Registered Trademark) sheets of 0.2 mm in thickness. Then, the pellets sandwiched between the Teflon sheets were subjected to hot pressing by keeping the pellets for 1 minute under application of a temperature of 160° C. and a force of 10 MPa by using a small-size hot pressing apparatus (size of a pressing board: 160 mm×160 mm made by Imoto Manufacturing Corp.). Thereby a film of 100 μm in thickness was obtained.

### EXAMPLE 5

### Preparation of Extrusion Piece

Respectively from the pellets produced in Examples 2 and 4, extrusion pieces of 5 mm×2.5 mm×50 mm were prepared by treating the pellets with an extruder (Model: LMM1, made by Atlas Electric Devices). The extrusion was carried out at temperature of 220° C.

### COMPARATIVE EXAMPLE 1

One gram of PMMA was dissolved in 10 g of toluene and 0.05 g of SAO:E that had not been surface-modified was added thereto, thereby obtained a mixture solution. After subjected to ultrasonic treatment, the mixture solution was cast on a glass board. Then, toluene was evaporated off therefrom. Thereby, a film of 100 μm in thickness was obtained.

### COMPARATIVE EXAMPLE 2

One gram of PMMA and 0.05 g of SAO:E that had not been surface-modified were mixed and then extruded for melting, mixing and kneading at 160° C., thereby obtaining pellets. The thus obtained pellets were subjected to hot-pressing in the same manner as above, thereby obtaining a film of 100 μm in thickness.

[Evaluation of Transparency]

The composite material films obtained in Examples 1 to 4 were evaluated in terms of transparency. The evaluation of transparency was carried out by measuring total transmittance in accordance with JIS K7361-1 (Test Method for Total Transmittance of plastics/transparent materials) by using an automatic haze turbidimeter NDH2000 (made by Nippon Denshoku Industries). Results of the evaluation are given in Table 1.

TABLE 1

| | TOTAL TRANSMITTANCE |
|---|---|
| SAMPLE | (%) |
| EXAMPLE 1 | 80 |
| EXAMPLE 2 | 78 |
| EXAMPLE 3 | 84 |
| EXAMPLE 4 | 81 |
| COMPARATIVE EXAMPLE 1 | 53 |
| COMPARATIVE EXAMPLE 2 | 46 |

As illustrated in Table 1, Comparative Examples 1 and 2 attained total transmittance around 50% only, meanwhile Examples 1 to 4 attained total transmittance around 80% respectively. To conclude, very good transparency was attained in Examples 1 to 4.

[Evaluation of Water Resistance]

The surface-modified SAO:E1 and surface-modified SAO:E2 were evaluated in water resistance. The evaluation of water resistance was carried out by measuring ultraviolet light intensity of samples before and after soaked in pure water for one hour. The measurement of the ultraviolet light intensity was performed by using fluorophotometer FP-6500DS (made by Nippon Bunko Co. Ltd.). Results, which are shown in Table 2, are relative values with respect to fluorescent intensity of non-modified SAO:E before soaking, where the fluorescent intensity of non-modified SAO:E before soaking is 100.

TABLE 2

RELATIVE FLUORESCENT
INTENSITY

| | | AFTER |
|---|---|---|
| | BEFORE | SOAKING WITH |
| SAMPLE | SOAKING | WATER |
| RAW SAO:E | 100 | 3 |
| SURFACE-MODIFIED | 98 | 95 |
| SAO:E1 | | |
| SURFACE-MODIFIED | 95 | 94 |
| SAO:E2 | | |

As described in Table 2, no large reduction in the fluorescent intensities of the surface-modified SAO:E1 and the surface-modified SAO:E2 were observed. To conclude, the surface-modified SAO:E1 and the surface-modified SAO:E2 showed very good water resistance.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. A stress-induced light emitting composite material, comprising at least:
stress-induced light emitting inorganic particles, which emit light at application of a mechanical effect thereon; and
a polymer material,
the stress-induced light emitting inorganic particles being not more than a wavelength of visible light in particle diameter and being surface-treated, and
the stress-induced light emitting composite material being transparent in a visible light range.

2. A stress-induced light emitting composite material as set forth in claim 1, wherein the stress-induced light emitting inorganic particles are surface-treated to have water resistance.

3. A stress-induced light emitting composite material as set forth in claim 1, wherein the stress-induced light emitting inorganic particles are surface-treated with a compound having an acidic group or an ester thereof.

4. A stress-induced light emitting composite material as set forth in claim 3, wherein the acidic group is at least one of phosphonic acid group, phosphinic acid group, sulfonic acid group, carboxylic acid group, and silanol group.

5. A stress-induced light emitting composite material as set forth in claim 1, wherein the stress-induced light emitting inorganic particles are not more than 200 nm in particle diameter.

6. A method for producing a stress-induced light emitting composite material, the method comprising:
subjecting to surface treatment stress-induced light emitting inorganic particles being not more than a wavelength of visible light in particle diameter; and
compounding the thus surface-treated stress-induced light emitting inorganic particles and a polymer material,
the stress-induced light emitting composite material comprising at least (a) the stress-induced light emitting inorganic particles, which emit light at application of a mechanical effect thereon, and (b) the polymer material, the stress-induced light emitting inorganic particles being not more than a wavelength of visible light in particle diameter and being surface-treated.

7. A method as set forth in claim 6, wherein:
in the step of subjecting to the surface treatment, a compound having an acidic group or an ester thereof is used to perform the surface treatment.

8. A method as set forth in claim 7, wherein the acidic group is at least one of phosphonic acid group, phosphinic acid group, sulfonic acid group, carboxylic acid group, and silanol group.

9. A method as set forth in claim 6, wherein the stress-induced light emitting inorganic particles are not more than 200 nm in particle diameter.

10. A method as set forth in claim 6, wherein:
the step of compounding comprises (a) subjecting, to an ultrasonic treatment, the stress-induced light emitting inorganic particles thus surface-treated and the polymer material, or (b) melting, mixing, and kneading the stress-induced light emitting inorganic particles thus surface treated and the polymer material.

11. Stress-induced light emitting inorganic particles, which emit light at application of a mechanical effect thereon, wherein the stress-induced light emitting inorganic particles are surface-treated to have water resistance.

12. Stress-induced light emitting inorganic particles as set forth in claim 11, wherein the surface treatment is carried out with a compound having an acidic group or an ester thereof.

13. Stress-induced light emitting inorganic particles as set forth in claim 12, wherein the acidic group is at least one of phosphonic acid group, phosphinic acid group, sulfonic acid group, carboxylic acid group, and silanol group.

14. A coating material comprises stress-induced light emitting inorganic particles as set forth in claim 11.

15. A coating material as set forth in claim 14, wherein the coating material is a water-based coating material.

16. A surface coating material comprises stress-induced light emitting inorganic particles as set forth in claim 11.

17. A method for producing water resistant stress-induced light emitting inorganic particles, comprising:
subjecting to surface treatment stress-induced light emitting inorganic particles so as to give the stress-induced light emitting inorganic particles water resistance.

18. A method as set forth in claim 17, wherein the surface treatment is carried out with a compound having an acidic group or an ester thereof.

19. A method as set forth in claim 18, wherein the acidic group is at least one of phosphonic acid group, phosphinic acid group, sulfonic acid group, carboxylic acid group, and silanol group.
